(19) United States
(12) Patent Application Publication
(10) Pub. No.: US 2005/0055246 A1
(43) Pub. Date: Mar. 10, 2005

(54) Patient workflow process

(76) Inventor: Jeffrey A. Simon, Marietta, GA (US)

Correspondence Address: Burns & Levinson LLP, Suite 300, 1030 Fifteenth Street, N.W., Washington, DC, 20005-1501, US

(21) Appl. No.: 10/935,448

(22) Filed: Sep. 7, 2004

Related U.S. Application Data
(60) Provisional application No. 60/500,563, filed on Sep. 5, 2003.

(51) Int. Cl. G06F 17/60

(52) U.S. Cl. 705/2

(57) ABSTRACT

The invention executes a novel patient workflow process on a tablet PC streamlines office visits allowing doctors to see more patients, maximize practice revenues and speed reimbursements, all of which significantly improves the doctor's quality of work and quality of life. The invention maintains and improves patient provider communication optimizing the encounter workflow. The invention, as a point-of-care product, is delivered on a wireless Tablet PC using secure wireless technology. The invention speeds the collection of information while allowing the physician to maintain eye contact with the patient. The invention allows the doctor to easily search, organize and display any information on patients, prescriptions and symptoms, in real time. Using embedded encryption and compaction technologies, the invention assures patient data is secure and meets HIPAA requirements. The invention improves Doctor/Patient Interaction, Communication and Relationship. The invention utilizes handwriting and voice capture and recognition. Routine activities are speeded by customizable templates and forms, check-lists and action lists adapted to each physician's style. Using the invention will reduce annual patient workflow costs, due to electronic collection and submission of transcriptions, coding, prescription, insurance, and referral information.

### CROSS REFERENCE TO RELATED APPLICATIONS

This application relates to and claims priority benefit under 35 U.S.C. § 119(e) to U.S. Provisional Patent Application Ser. No. 60/500,563, entitled “Patient Workflow Process”, filed Sep. 5, 2003, which is hereby incorporated by reference in the entirety and made part hereof.

### FIELD OF THE INVENTION

The present invention relates to a system and method for managing patient healthcare by a physician's practice and, more particularly, to a system and method for automating the physician/patient encounter that follows the physician's traditional practices with a mobile, unobtrusive application that speeds medical practice activities.

### BACKGROUND OF THE INVENTION

Healthcare delivery is unique for each patient. The physician requires accurate records and must pay detailed attention to ensure correct treatment based on patient history, heredity and social practices and prevent damaging drug interactions. In recent years, healthcare is increasingly regulated, requiring more extensive documentation for insurance reimbursement and reduction of malpractice liability.

A physician's time is his or her most valuable resource. As medical records become ever more detailed and complex, the need exists for automated processes for collecting, storing, transmitting, and retrieving patient medical information becomes more critical. Historically, hand-entered medical records were very brief and were sometimes of limited value for future care, either because entries were illegible, used non-standard abbreviations, lacked sufficient detail, or were difficult to search. It has been widely reported in the literature that such difficulties resulted in negative effects on clinical judgment, patient care plans, medical record audits, medical education, and physician performance evaluation.

Information management is key a successful practice. Some attempts have been made to computerize specific aspects of health care delivery apart from the clinical patient record. Desktop computer systems are not portable. They restrict mobility and the physician cannot use them directly, so traditional paper and desktop systems are both required and coordination and redundant data entry are needed. Conventional notebook computers are somewhat mobile but keyboard entry is slow and interrupts physician/patients rapport. Personal digital assistants, such as the pal™ manufactured by palmOne, Inc. of Milpitas, Calif., have great portability, but are limited to small service applications because of limited computing power, small storage capacity, poor readability, small screen size and painful data entry techniques. All of those types of solutions lack resilience.

Therefore, needs exist in the medical community for a productivity-enhancing system and method that meets the mobile healthcare professionals' needs to quickly, easily and intuitively access and enter information during patient interaction regardless of location or the availability of network services.

It is an object of the invention to provide a completely integrated physician practice workflow solution.

It is an object of the invention to maintain and improve patient-provider interaction, communication, and relationships by optimizing the encounter workflow.

It is an object of the invention to speed the collection of information while allowing the healthcare professional to maintain eye contact with the patient.

It is an object of the invention to streamline office visits allowing doctors, clinicians, nurse practitioners and other healthcare professionals to see more patients, maximize practice revenues and speed reimbursements, all of which significantly improves the doctor's quality of work and quality of life.

It is an object of this invention to provide a system and method that focuses on the needs of physicians as they deliver patient healthcare and must meet the physician's demands for mobility, ease of use, time efficiency, information delivery and security.

It is another object of the invention to provide a device and method to support patient information collection and retrieval without interfering with care delivery or physician/patient rapport.

It is another object of the invention to allow the healthcare provider to easily search, organize and display any information on patients, prescriptions and symptoms, in real time.

It is yet another object of this invention to provide a hand-held device and method that meets the mobile healthcare professionals' needs to quickly, easily and intuitively access and enter information during patient interaction regardless of location or the availability of network services.

It is yet another object of the invention to deliver a point-of-care product via a wireless hand-held device using secure wireless technology.

Still another object of the invention is to utilize handwriting and voice capture and recognition, and to speed routine activities by customizable templates and forms, checklists and action lists adapted to each physician's style.

Another object of the invention is to reduce annual patient workflow costs, due to electronic collection and submission of transcriptions, coding, prescriptions, insurance and referral information.

Another object of the invention is to use embedded encryption and compaction technologies, assuring that the patient data is secure and meets HIPAA requirements.

Other objects of the system and process described herein will, in part, be set forth below and in parts, be obvious to those of ordinary skill in the art from the following description of certain illustrated embodiments.

### SUMMARY OF THE INVENTION

The present invention is based on the premise that mobile healthcare professionals need to quickly, easily, and intuitively access and enter information during patient interaction whether at their practice or visiting the patient at the hospital.

The present invention delivers a completely integrated physician practice workflow solution. The system uses integrated state-of-the-art software and database on a wireless mobile computing system capable of advanced handwriting and speech recognition, such as the Tablet PC, manufactured by the Microsoft Corporation of Seattle, Wash. The software and database are combined with a proprietary interface and command structure, plus physician-oriented self-help to enable easy-to-learn and easy-to-use training. The implementation of the patient workflow process of the present invention on the Tablet PC mobile computer system is hereinafter referred to as the Tablet MD. The Tablet MD captures and deciphers the practitioner's clinical documentation on the Tablet PC, which is similar in size and portability to the charts currently used.

The present invention was developed to mirror a physician's current office practice procedure. The Tablet MD user can instantly create or update a medical record and treatment plan, execute the prescribed treatment plan, retrieve the results and return them digitally, wirelessly and contemporaneous to the physician-patient encounter. All outstanding information and unfinished tasks are automatically tracked, so the physician is assured that their clinical and regulatory obligations are met.

The present invention solves workflow problems encountered with traditional desktop, laptop and personal digital assistant systems because it allows source documents to reside within the unit. When source documents are paper based, the next logical step in the entry process is reentry, which is not a productive use of time. Users can pull up pre-developed individual-doctor-customized forms including drop-down lists and dialog boxes to ease data entry.

The inventive method optimizes the patient workflow process by delineating and demarking the steps taken during the healthcare professional-patient encounter. Electronic medical record applications are interfaced to display patient information and initiate the healthcare professional-patient encounter. Additional patient information is gathered, and the information is entered in an electronic system customized to a particular physician's preferences A patient workflow is generated from the entered information. The patient workflow is modified during assessment by the healthcare professional. The patient examination is then conducted according to the generated patient workflow. The physician dictates information into a microphone attached to the Tablet MD apparatus. The dictated information is captured into an audio file, and the audio file is converted into a voice profile for a particular physician. The voice profile is submitted for transcription. Finally, diagnostic and prescriptive information is compiled for payor authorization and processing.

The inventive system optimizes the patient workflow process and includes a wireless output device for displaying health related information (i.e. diagnostic and plan care information), a wireless input device for entering diagnostic and plan care information, a memory for storing a computer program, a microphone for dictating descriptive data and other patient-related information, and a processor for executing the computer program.

The inventive system compiles, synchronizes, and communicates health related information, by linking the health professional to medical records, payor insurance or authorization guidelines, reference information and service providers. The system includes a computer in data communications with one or more internal and external computer databases or networks, a wireless portable computing device made up of an input device and display device, and a memory for storing a computer program, and which prescribes a suggested workflow for the healthcare professional-patient encounter.

### BRIEF DESCRIPTION OF THE DRAWINGS

FIG. 1 is a diagram illustrating the steps comprising the inventive process, as described herein;

FIG. 2 is an illustration of a login screen used to access the Tablet MD application;

FIG. 3 is a workflow diagram of the input, and process engine components of the patient workflow process

FIG. 4 provides a sample illustration of one embodiment of the active patient list screen in accordance with the inventive arrangements of the Tablet MD application;

FIG. 5 is a screen shot of one portion of the interactive website that prompts the healthcare professional to select one of several component elements in accordance with the inventive arrangements of the Tablet MD application;

FIG. 6 is a screen shot of one portion of the interactive website that prompts an authorized database administrator of a particular physician's practice to select one of several elements in accordance with the inventive arrangements of the Tablet MD application;

FIG. 7 is a screen shot of one portion of the interactive website that prompts the healthcare professional to select one of the element options for the component that he/she wishes to build;

FIG. 8 is a screen shot of one portion of the interactive website that prompts the healthcare professional to build one or more of the aforementioned components by selecting or activating several fields as show, and assigning a name to the particular component that has been created;

FIG. 9 is a screen shot of one portion of the interactive website that allows the healthcare professional to fill in default values for various data fields in the example component shown;

FIG. 10 is a form builder, as illustrated in a sample screen shot of the interactive website by which the patient workflow process is implemented;

FIG. 11 is a work flow builder that can be customized for each healthcare professional in a particular medical practice in accordance with the inventive arrangements of the Tablet MD application;

FIG. 12 is a high level architecture diagram illustrating one embodiment of the arrangement of the network used to implement the inventive process;

FIG. 13 is a diagram comparing the amount steps taken from the initial point of physician dictation to filing of the patient record as used in a conventional workflow process, to that of the streamlined steps that comprise the Tablet MD application;

FIG. 14A is a table listing of the operations performed by the business rule engine, and the definitions of the listed operations;

FIG. 14B is a continuation of the above-referenced table listing;

FIG. 14C is another continuation of the above-referenced table listing;

FIG. 15 is a screen shot of one portion of the interactive website dedicated to business rule management that prompts the healthcare professional to select elements to create a customized business rule group;

FIG. 16 is an example of a selected business rule element;

FIG. 17 is a screen shot of one portion of the interactive website that is accessed by the healthcare professional during the encounter with the patient in order to obtain the patient's name, reason for appointment and to assign a workflow to the patient;

FIG. 18 is a screen shot of one portion of the interactive website that is used as a face sheet for the patient's biographical and profile information;

FIG. 19 is a screen shot of one portion of the interactive website that is used to record the vital signs observed for a particular healthcare professional-patient encounter;

FIG. 20 is a screen shot of an add form for a particular patient;

FIG. 21 is a sample screen shot of the entire patient listing for a client medical practice;

FIG. 22 is a sample screen shot of one portion of the interactive website used to edit a patient's biographical information;

FIG. 23 is a screen shot of one portion of the interactive website that is used to record details of the patient's insurance plan and coverage;

FIG. 24 is a screen shot of one portion of the interactive website that is used to record contact and address information for the patient's insurance plan; and

FIG. 25 is a screen shot of one portion of the interactive website that provides and records the medical history for the particular patient that is examined.

### DESCRIPTION OF THE PREFERRED EMBODIMENT

The underlying technology for the preferred embodiment of the present invention is based on an architecture which allows for the easy addition of new features and upgrades, the customization of processes, is scalable from at least five to hundreds of physicians, and is supported through tools and computer programming languages, which are today's industry standards. In most cases, current products attempting point-of-care solutions are made up of various pieces of the process, with different applications—tied together through many menus and displays—which require the user to learn different commands and actions at each stage of the process.

The invention delivers each function in a truly integrated environment with consistency and accuracy. The implementation is built from the ground up utilizing state-of-the-art architecture. The preferred embodiment is functionally extensible and able to integrate and interface to other systems easily. It is a scalable solution, built with industry leading products, and is programmed in Microsoft Visual Studio.NET.

Information management is the key to a successful practice, beginning with check-in, through collection of vitals and symptoms, testing, consultations, diagnosis, treatment, and claim submission. The preferred embodiment of the patient workflow process addresses the six essential steps in this workflow.

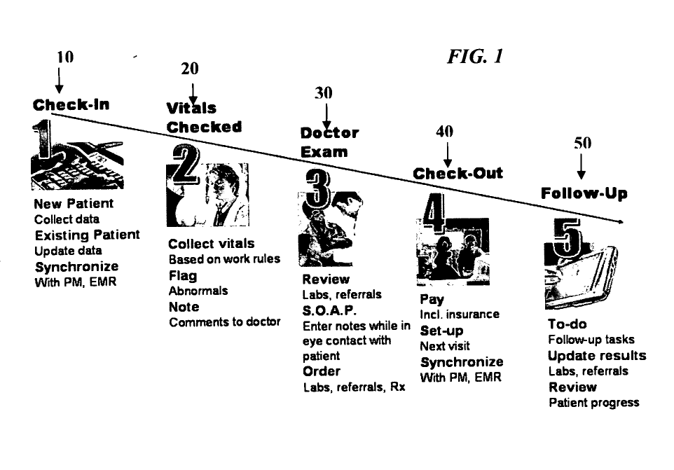

There are at least five steps in the process, as illustrated in FIG. 1. The healthcare provider can add, eliminate or reorder steps and their contents to fit the medical practice's business process requirements.

The check-in step 10 is the first step. This step transparently interfaces with BackOffice Electronic Medical Record and Practice Management applications to display information required by the clerical staff to initiate pre-exam test (Blood analysis and X-Ray) requirements, gathering of patient information for medical history, appointment scheduling, chief complaint, Physician workflow selection, insurance setup or change, and follow-up. This step may require synchronization between many established or new auxiliary systems in this collection process.

The patient's vitals signs are checked in the second step 20. By implementing step 20, a healthcare professional (e.g. nurse, physician assistant, or physician) is able to review the reason for the visit and modify the information as necessary and check and record vitals such as temperature, weight, height, blood pressure, and pulse, to name a few. In addition, the workflow may be modified based on a reassessment of the type of visit and chief complaint.

The third step 30 consists of the physical examination, including the time spent by the physician or doctor in reviewing the patient's records and vitals plus any lab orders, referral information, or medical history. The doctor then performs the examination including the preparation of progress notes—subjective, objective, assessment, plan, prescriptions, and orders —required labs, referrals, and follow-up requirements. The process includes the generation of CPT, ICD-9/10, and E&M codes for insurance submission purposes.

The patient check-out is initiated in the fourth step 40. The patient returns to the front office to complete billing requirements, set up follow-up appointments, set-up labs or referrals, and output any paperwork from the visit which includes prescriptions or documentation. The clerk or medical assistant can also synchronize information collected with the back office computer applications.

Subsequently, the clerks, physician, and other healthcare professionals complete the follow-up step 50. This step presents to any actions which need to be taken or has been taken and requires review. The information presented therein is commonly referred to as a tickler. This term is well-known in the art and in colloquial layman's terms. The tickler is maintained in the application by healthcare professional and date, healthcare professional and patient and date, or patient and date.

Other embodiments of the inventive process may include the step of algorithm coding. This step analyzes the objective, assessment, and plan input from the physician and determines the proper CPT, E&M and ICD-9/10 codes to utilize for classification and billing. If decisions are required, the patient workflow process application sets up a tickler for instructions from the doctor.

Technology Utilized

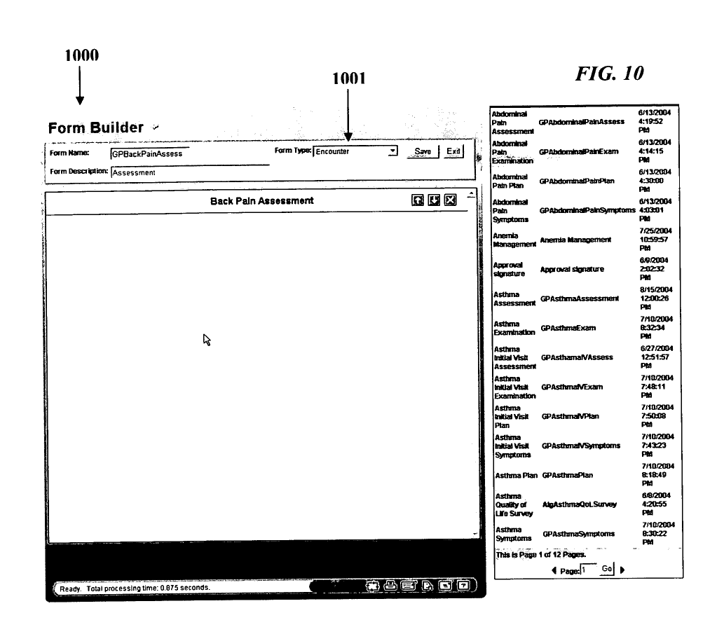

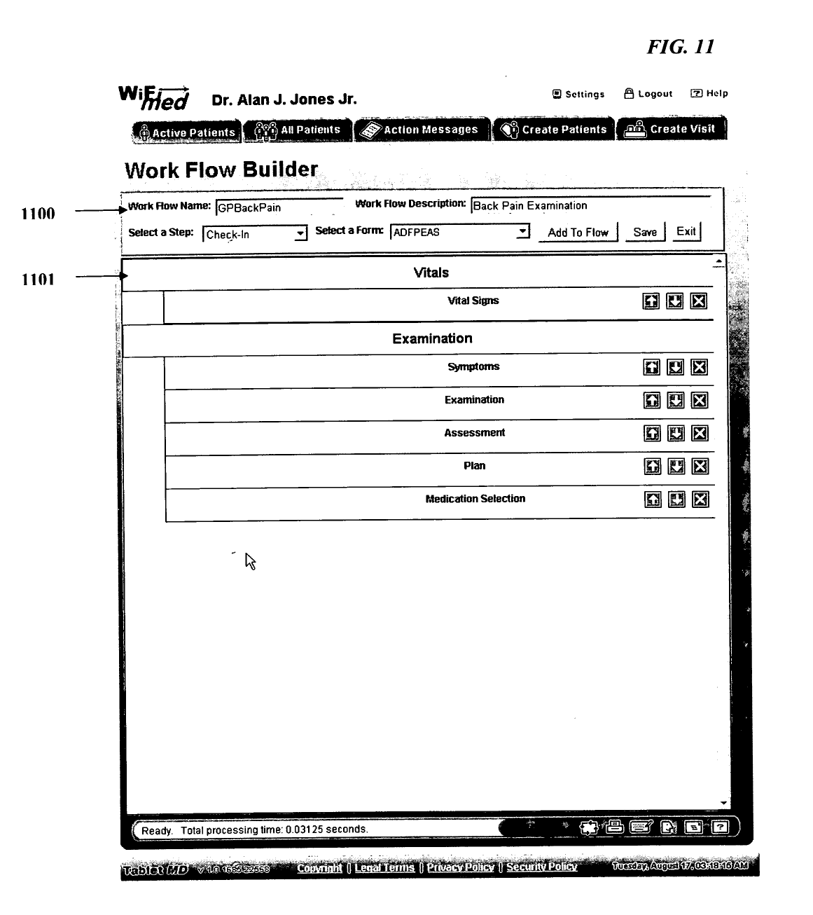

The preferred embodiment of the present invention incorporates a set of technology unique to implementation of the patient workflow process—Tablet MD. The invention uses technologies illustrated in FIG. 10 and their implementation to provide a solution which fits the needs of the modern healthcare practice and its various governance requirements from government and insurance mandates. These technologies include industry accepted operating systems geared to be easy to use by small to medium sized medical practices and a series of original developments to check and inform the physician of non-compliance.

Tablet MD uses as its interface a web browser technology built on top of a relational database. The initial implementation has Microsoft Internet Explorer as the web browser and SQL Server as the database. The web browser and server are well known in the art. The inventive system is designed to be executed on a Tablet PC which requires understanding the Tablet PC stylus and allow single tap mechanics rather than a mouse like environment with right and left button clicks. The system uses Microsoft's Visual Studio.NET languages as well specific Dynamic HTML and coding facilities.

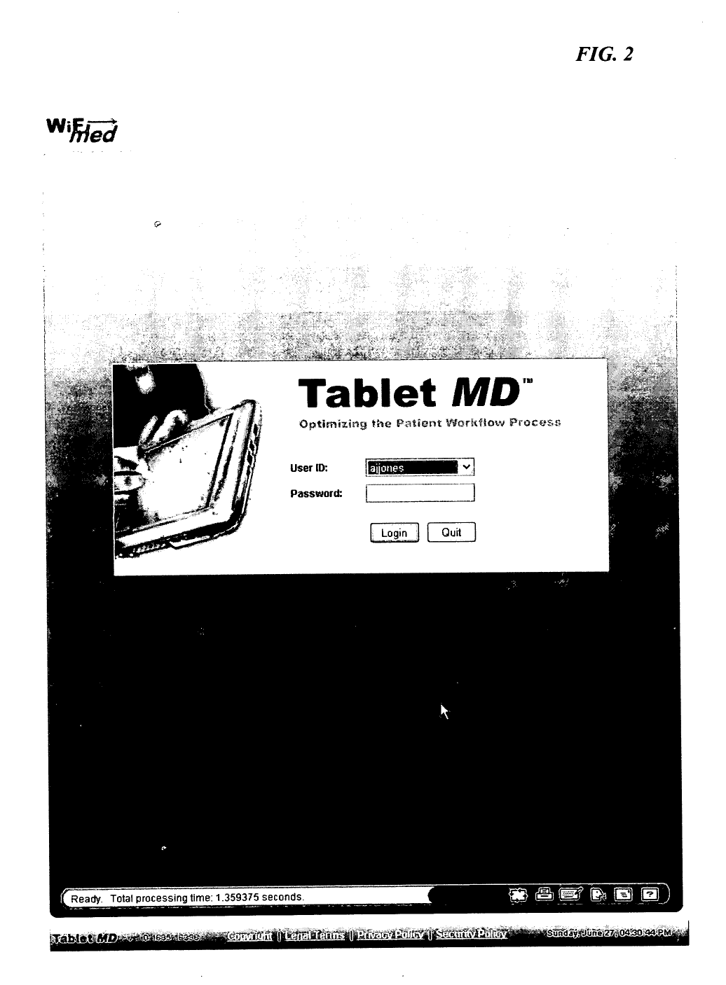

As incorporated into the patient workflow process, the preferred embodiment of Tablet MD manages a wide variety of practice documentation including but not limited to electronic forms, scanned documents, OCR documents, charts from medical equipment—EKG, EEG, Ultrasound, and PAC output. These forms of documentation are referenced in the process engine of FIG. 2.

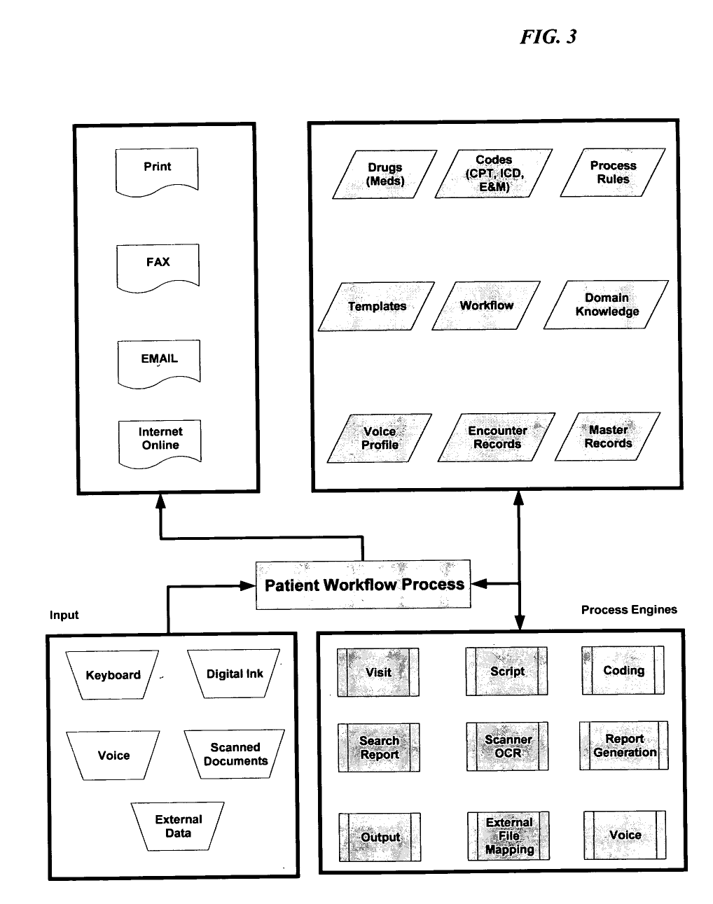

The various technologies and implementations of the preferred embodiment as detailed in this section are Personalization, Synchronization, Voice recognition, Wireless Independent Client, Business Rule Generation, Specialized Databases, Cross Mapping Technology, Segmented Workflow, and Security. Each component of the patient workflow process and the inventive implementation of the Tablet MD is illustrated in FIG. 3.

1. Personalization

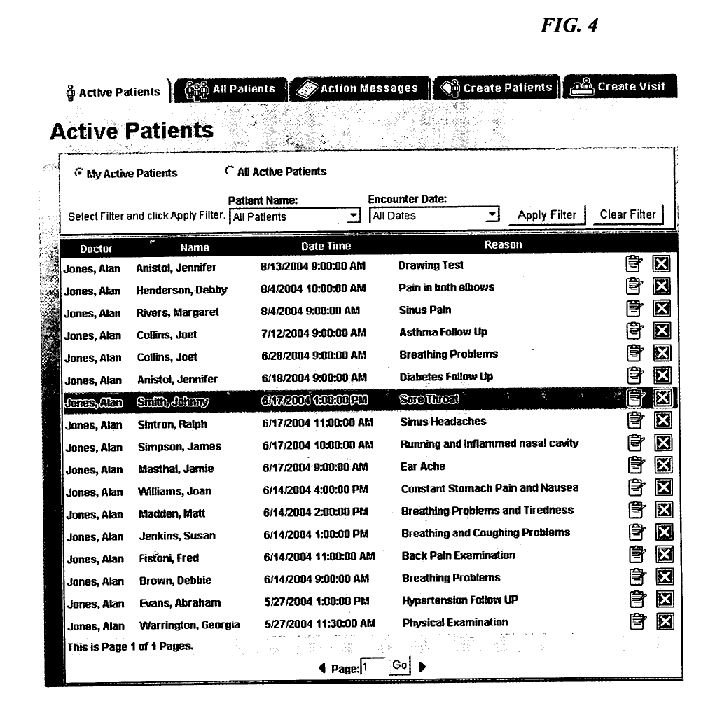

To address each physician in the practice as an individual and not merely as a group, Tablet MD provides a series of processes and technologies to allow for the customization of the input interface. This is done with a number of building blocks, including but not limited to component management, form generation, as set forth in item 500 of FIG. 4.

a. Component Management

Tablet MD uses a process which allows the selection of data elements from predefined tables, combined with options, graphical layout, and default values to be brought together as reusable components 600 which can either be used as a single form or combined with other components 600 to implement a form. The user can select component elements 700 from a variety of tables existing in Tablet MD which are segmented by specialty and process.

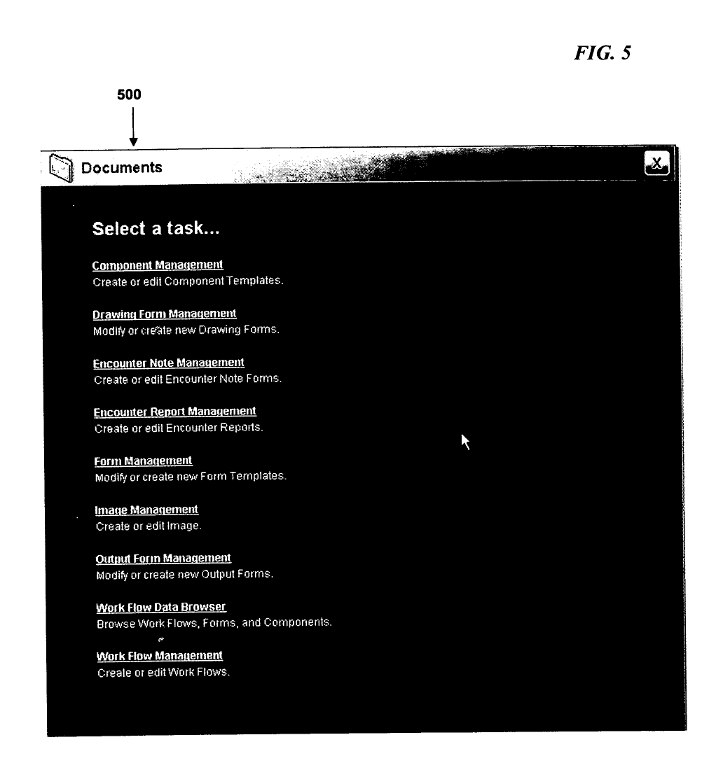

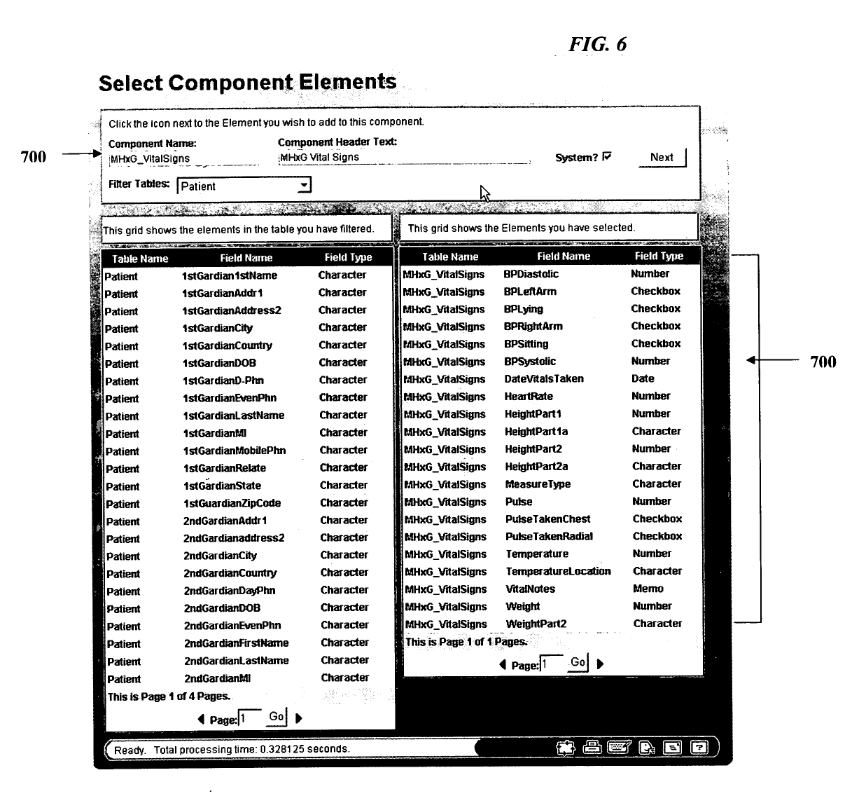

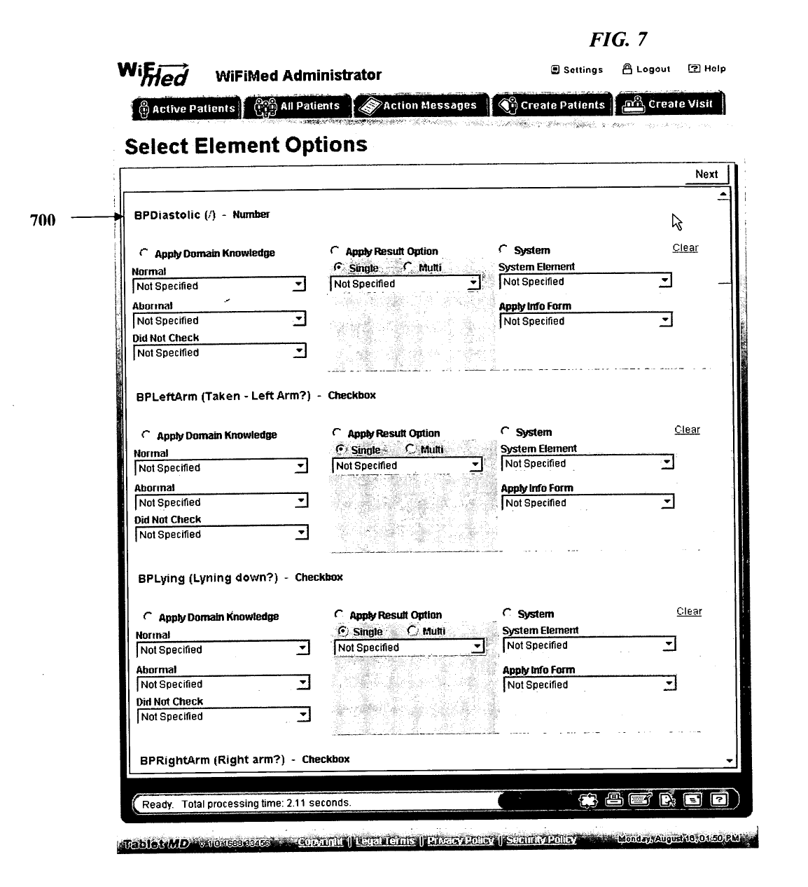

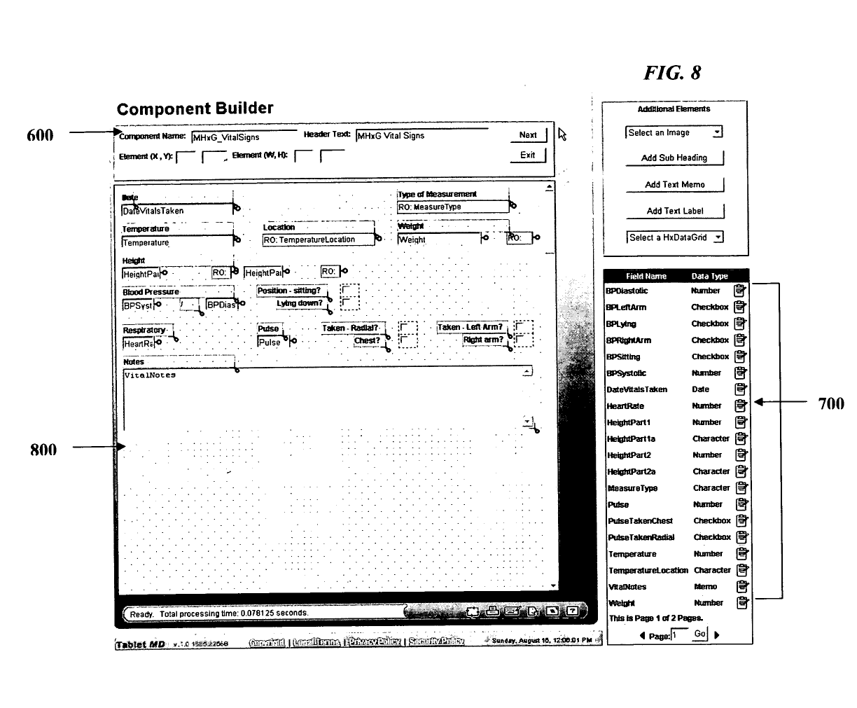

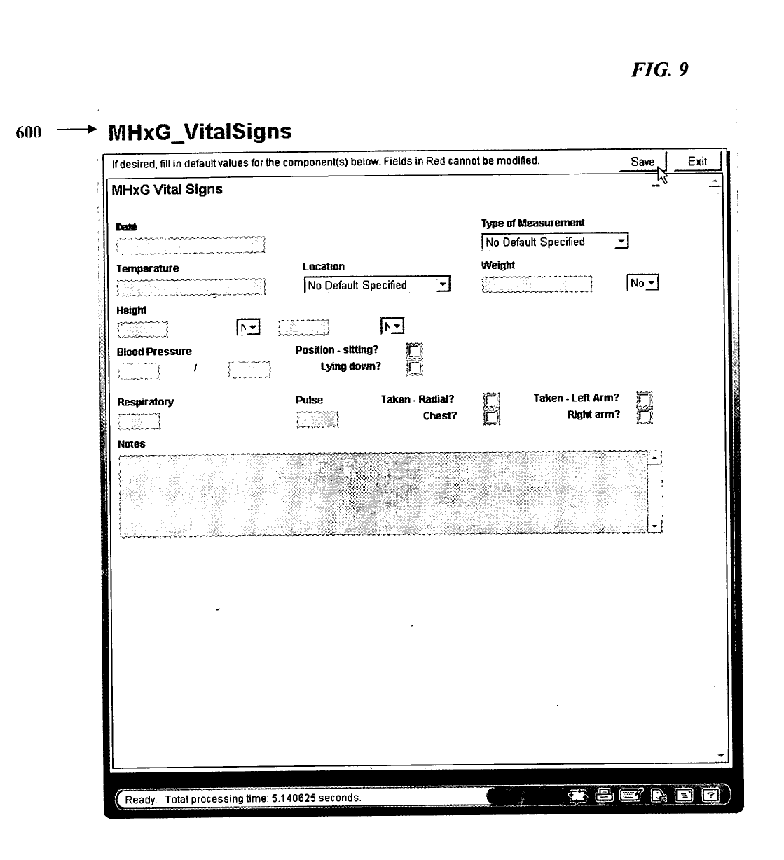

Components 600 may act as building blocks of forms or as individual components called system components used to build and customize all functions of Tablet MD. Once the component elements 700 are selected, the user can assign specific domain knowledge to a display element using pick lists and drop down windows, as seen in FIG. 5. Associated with each component element 700 is the ability to display forms containing information gathered by Tablet MD, such as laboratory results. This capability is implemented through the Info Form drop down box. The preferred embodiment also provides the ability to attach system functions to a particular data element such as medications and allergies.

The next step in component generation gives the user the ability to graphically drag and drop the selected elements on a layout page. Selected component elements 700 may be table elements, headers, text, labels, or grids. The grids 800 are specially designed elements which bring together specific information about the patient such as allergies, hospitalizations, medications, and immunizations. The grids 800 also allow for the modification or addition of additional information not already generated by a patient or physician.

Once the layout is complete the user then has the ability to add default information to a component 600 which will be displayed when the encounter is initiated for a patient. The default information is specific to the individual using the component.

b. Form Generation

Once components 600 have been built, they can be combined with other components 600 to build forms in a Form Builder 1000, as seen in FIG. 10, which will be used in a patient encounter. The forms are segmented by specialty—orthopedics, ophthalmology, family practice. Forms are built using components 600 which are ordered the way the physician wants the components to appear in the form. Forms may be of different types 1001 depending on how a form is to be used. Examples of types 1001 are encounters, addendum notes to previously completed encounters, or prescriptions to name a few.

c. Workflow Generation

Forms are then grouped into procedures to be used by healthcare staff. These procedures are called workflows 1100 and are the heart of the Patient Workflow Process. The forms are grouped under one or more of the workflow steps 1101—check in, vitals, examination, check out. The present embodiment of the invention has the capability to add more workflow steps 1101 such as orders, education, or reminders. All workflow steps 1101 can be created, modified and reordered by the practice.

2. Synchronization

The inventive process permits the utilization of the network server to maintain and backup the client Tablet MD systems transparently. This minimizes or eliminates the need for a practice to hire proficient computer staff, thus reducing costs, and minimizing errors. This includes data updates, including but not limited to medical classification systems, drug databases, new forms, and business rules. Every action taken by a user on either a Tablet MD connected through wireless protocols, or desktop or notebook computers connected over local area networks is captured in a journal file. The synchronization process takes place either automatically or upon initiation by the user, the practice server, or during actual network operations. These files act in two modes—backup and coordination.

In order to insure information collected is not lost, synchronization processes move the generated information on a field by field basis to the practice server when the Tablet is within wireless range of the server or is connected by an on/off-site LAN. Once the files are moved a procedure is initiated to update the server database as a backup. Each server also has a RAID sub-system to further backup the information. As a further backup, the preferred embodiment provides a service to automatically synchronize practice database modifications with a corporate facility transparent to the practice. Processes are started in the background and initiate the actions which need to be executed automatically. In other words, with the practice has a practice management system to provide scheduling and billing, Tablet MD will automatically initiate a transfer of new and changed appointments from the practice management system to Tablet MD.

Coordination takes several forms. The information backed up to a server, also can be used to synchronize with another user's Tablet PC or a series of servers situated at various geographic locations for a practice. This coordination insures the practice at all times its users are seeing the same and current data for a patient.

The synchronization process is also used to update practice information such as new forms, compliancy requirements, and drug databases. This information is automatically pushed out to user Tablet MD environments and made immediately available to desktop and notebook computer users. A system service is initiated to review the audit trail generated while a user works with Tablet MD and then sends the local Tablet PC records to the server automatically updating the database there.

3. Voice Recognition

The preferred embodiment uses various forms of input (i.e. checkboxes, radio buttons, drop down lists, keyboard entry, and handwriting) when using a Tablet MD. The easiest form of entry is the human voice. In the past, this has required extensive training by the user to make it work effectively at the 98% accuracy range. The inventive process described herein incorporates a technique which allows the training to take place transparently.

Using the technique, the physician dictates in much the same manner that is conventionally used today. In contrast to conventional dictation, however, the Tablet MD captures dictation in a WAV file, and simultaneously uses current market place applications combined with voice technology elements to convert the WAV file into a document and produce a voice profile. The WAV file, preliminary document and voice profile are submitted to a specialized transcription service that corrects the document while listening to the WAV file. As corrections are taking place, the voice profile is automatically updated.

4. Wireless Independent Client

A unique characteristic of the inventive process is its ability to allow a user to utilize Tablet MD in a non-broadcasting environment. This reduces installation time and costs, as the wireless Tablet MD does not need to be within range of the server. The user can take the Tablet MD anywhere the user desires including hospitals, home, or even in their car. During use in the wireless environment, the Tablet MD captures all information being generated. The Tablet MD can work independent of any server in “thick client” mode (the Tablet PC may run independently of a server because all the application is on the Tablet PC and is updated through the synchronization process.

With limited amount of disk space on the Tablet MD and the need to maintain complete patient records on the Tablet MD as well as the server, the inventive process implements a set of indexes or pointers that minimizes the amount of information duplicated by the system in a highly efficient manner. This minimization allows for a large amount of patient data to be available on the Tablet MD at any time, including all the types of information previously mentioned hereto.

5. Business Rule Generation

To implement the inventive process within the Tablet MD application, the system provides a parameterized business rule engine. The preferred embodiment addresses several situations where business rule are initiated, including but not limited to Form initiation in PWP (FRM), Form save (NXT), Encounter initiation (ENI), Encounter completion (ENC), Order receipt (ORD), Synchronization (SYN), Data element entry (DEE), User login (USI), User logout (USO), System actions (SYS), Tickler action (MSG), Display/Report Generation (RPT), and Encounter Report Generation. Other embodiments of the invention may also address additional situations in which business rules are applied.

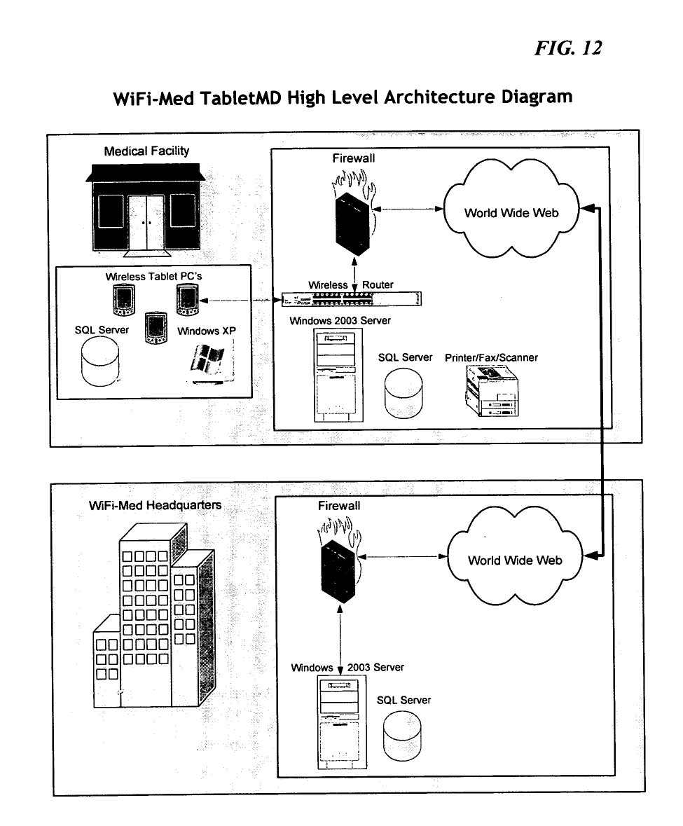

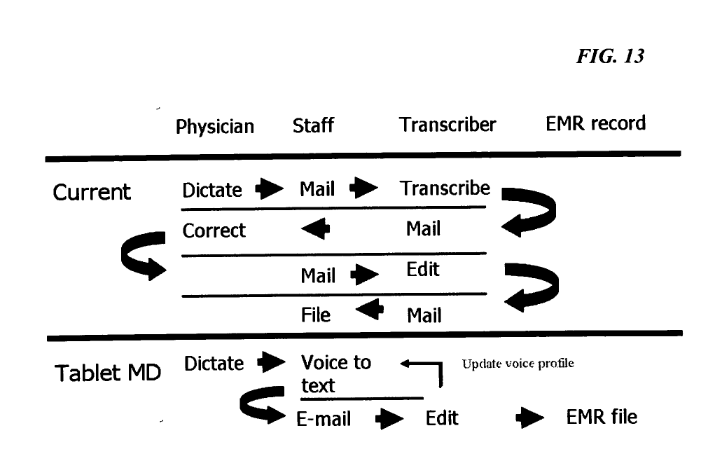

Business rules consist of a number of actions which can be initiated. The business rules engine initiates a process which produces a PWP flow used to manage Tablet MD operations. These operations are shown in FIGS. 12A-C. A graphical parameterized approach has been developed to provide business rule implementation. The initiation of business rule action is through the rule browser: The user selects the event 1500 which will initiate a business rule 1502 such as “Encounter Form Save”, selects the object 1501 to apply the rule 1502 to, and then determines if a template has been developed which can be used or modified. After this action, the patient workflow process engine brings up the builder to be used in the construction of the rules or a copy of the template to be modified.

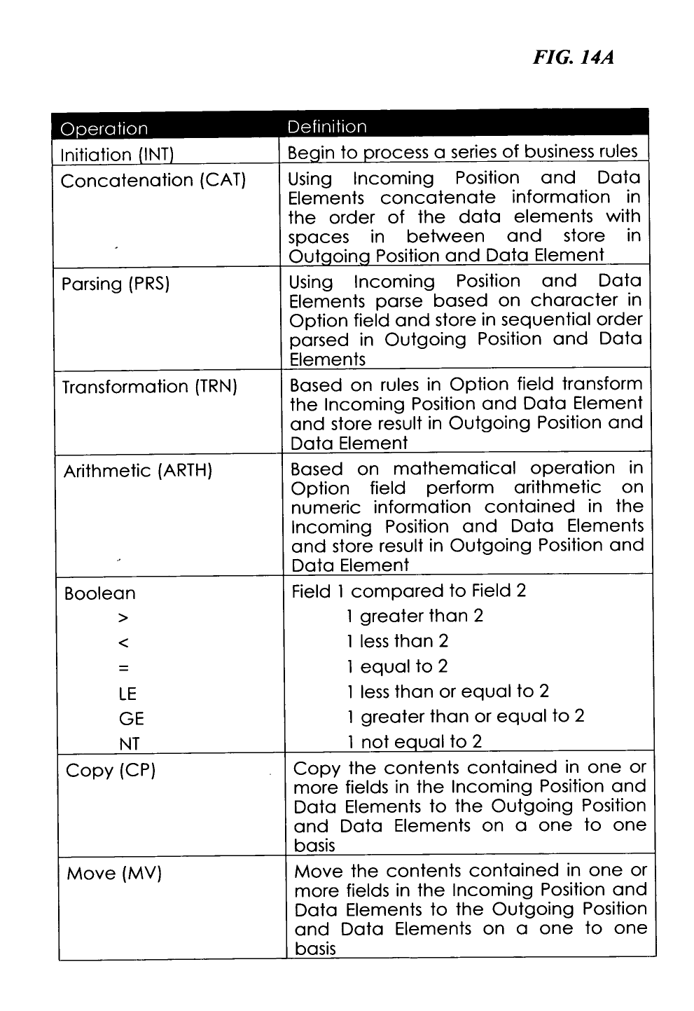

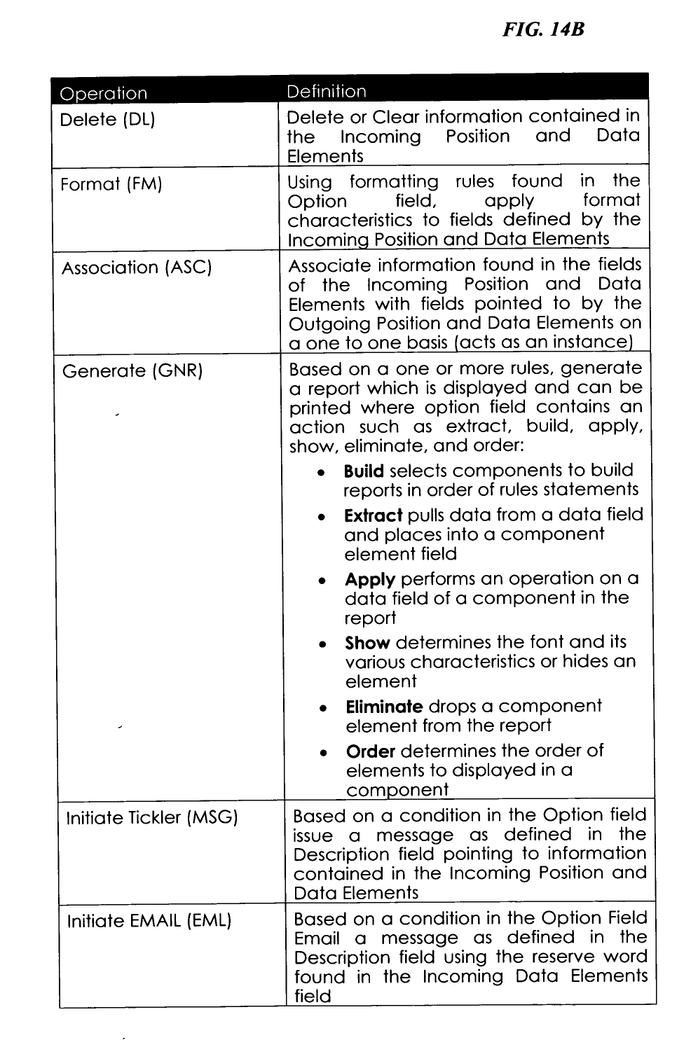

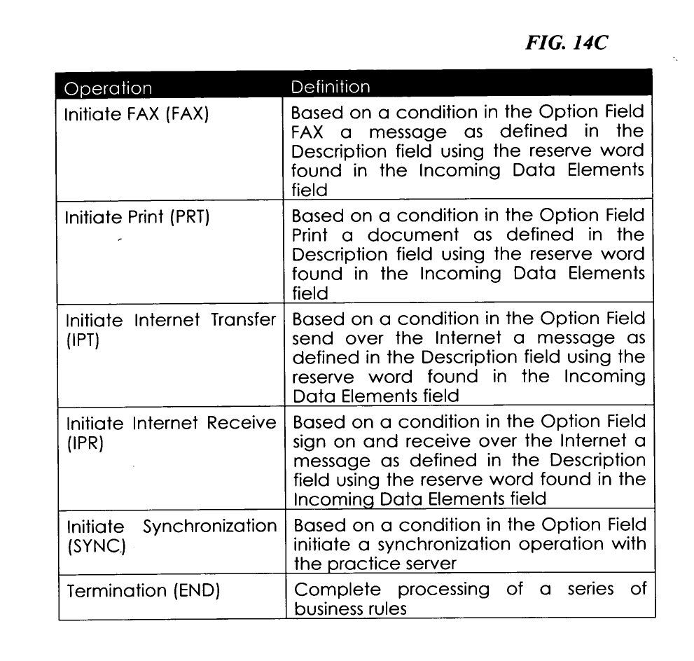

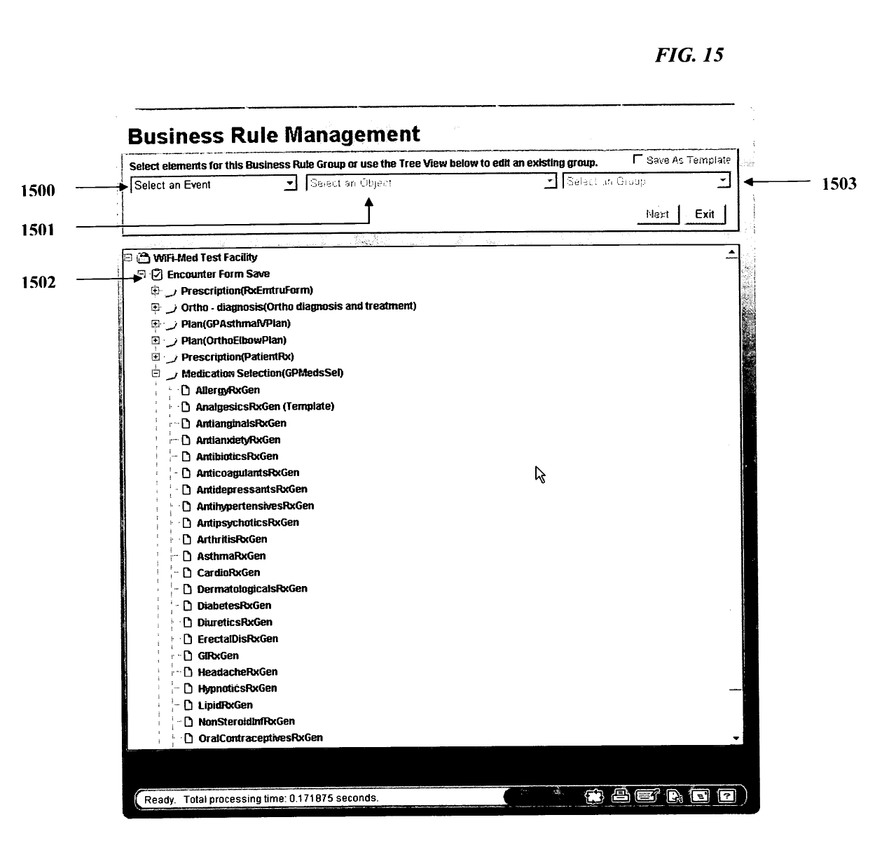

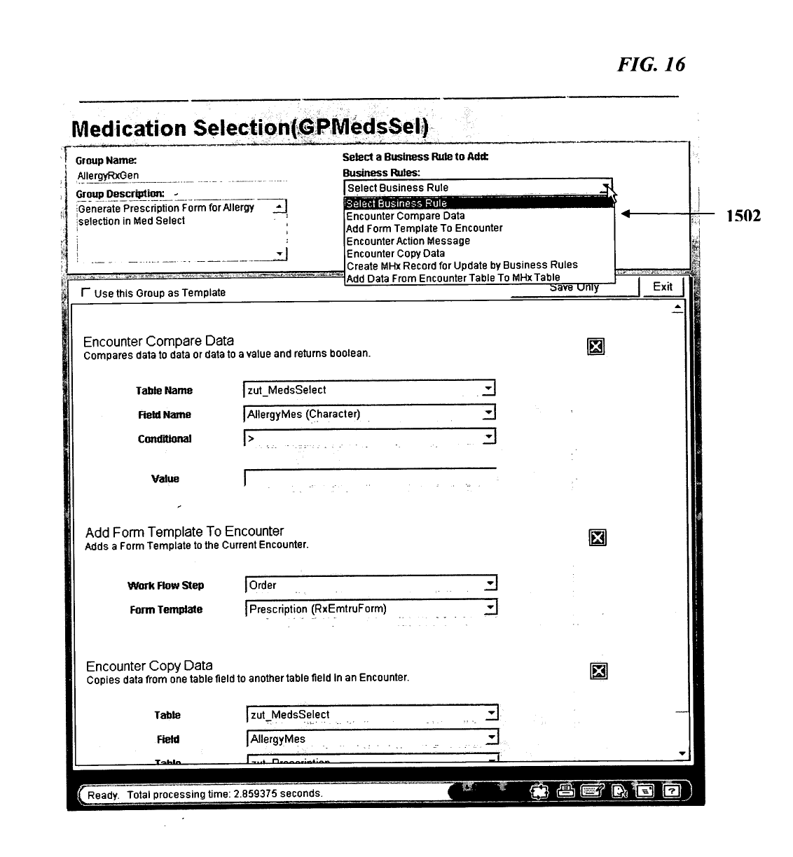

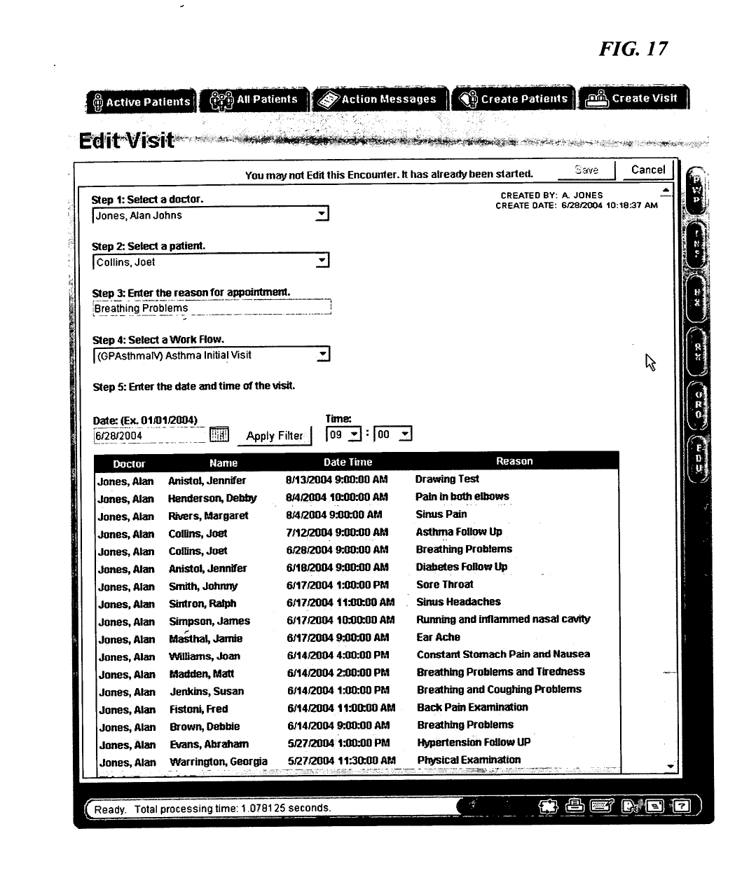

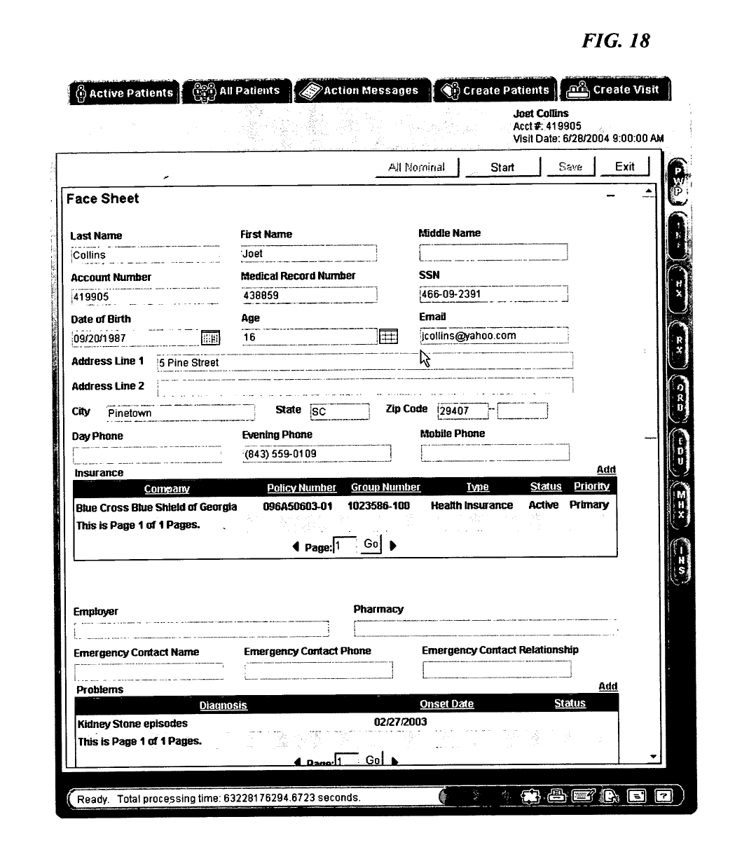

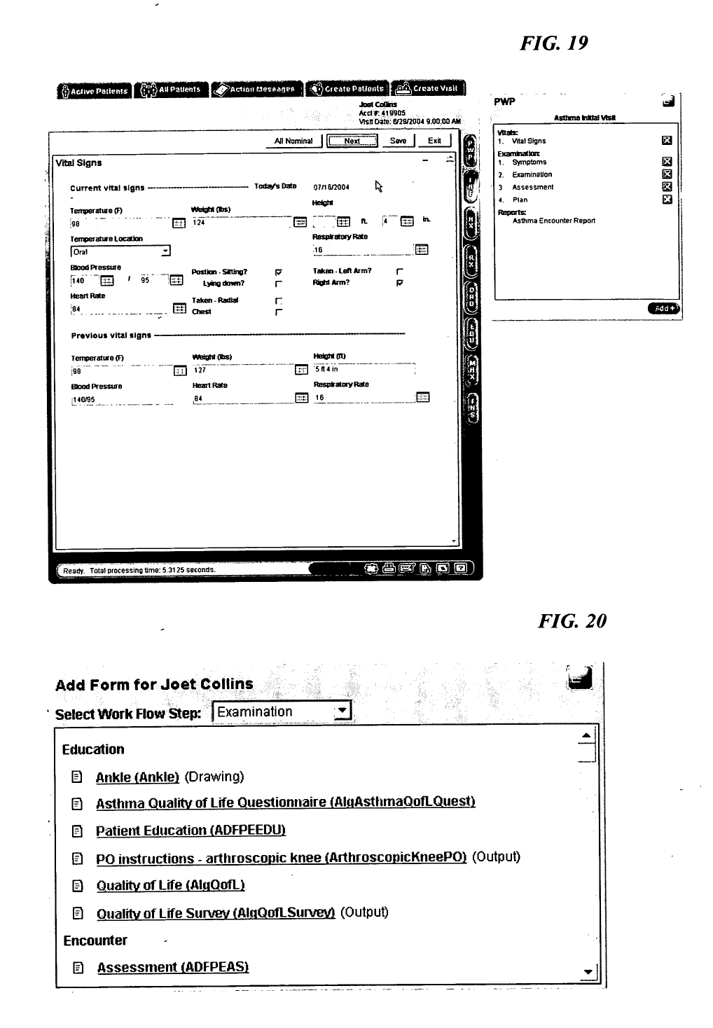

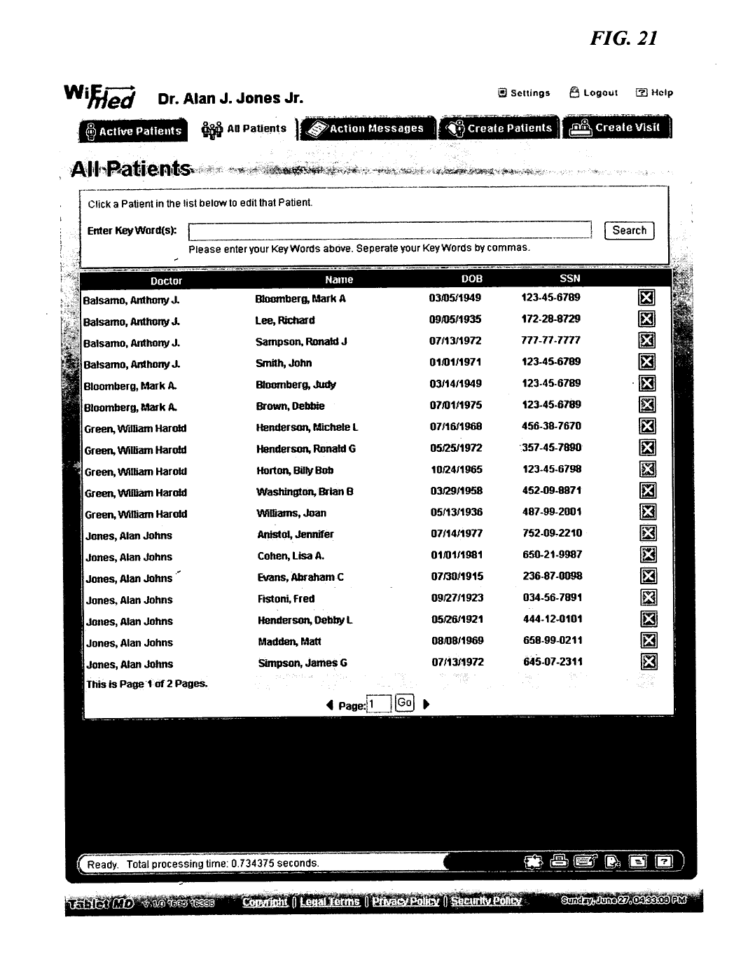

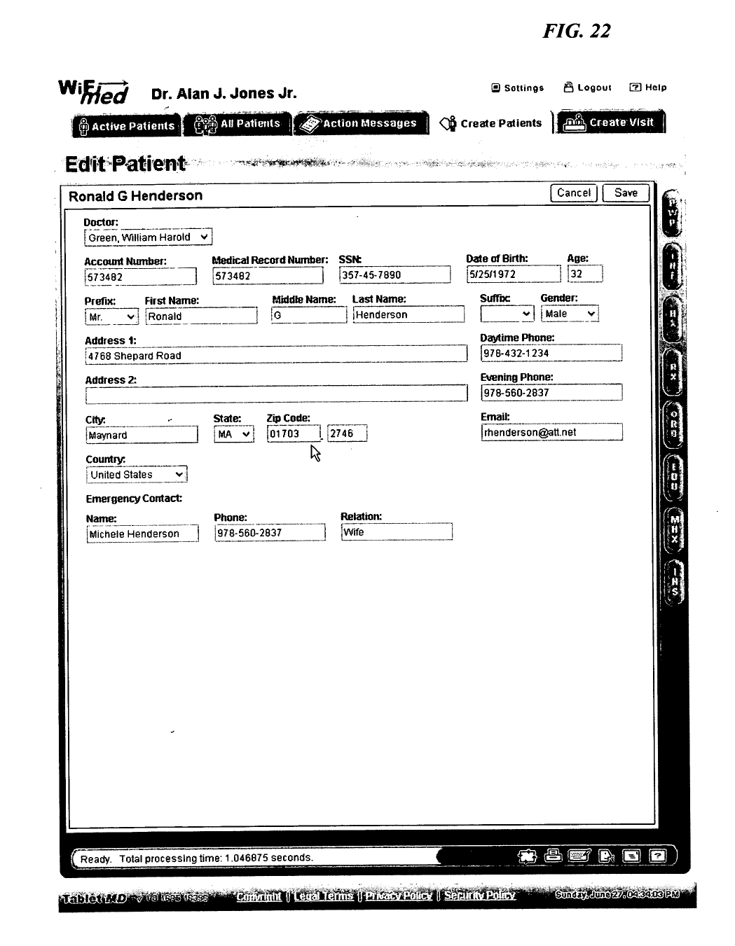

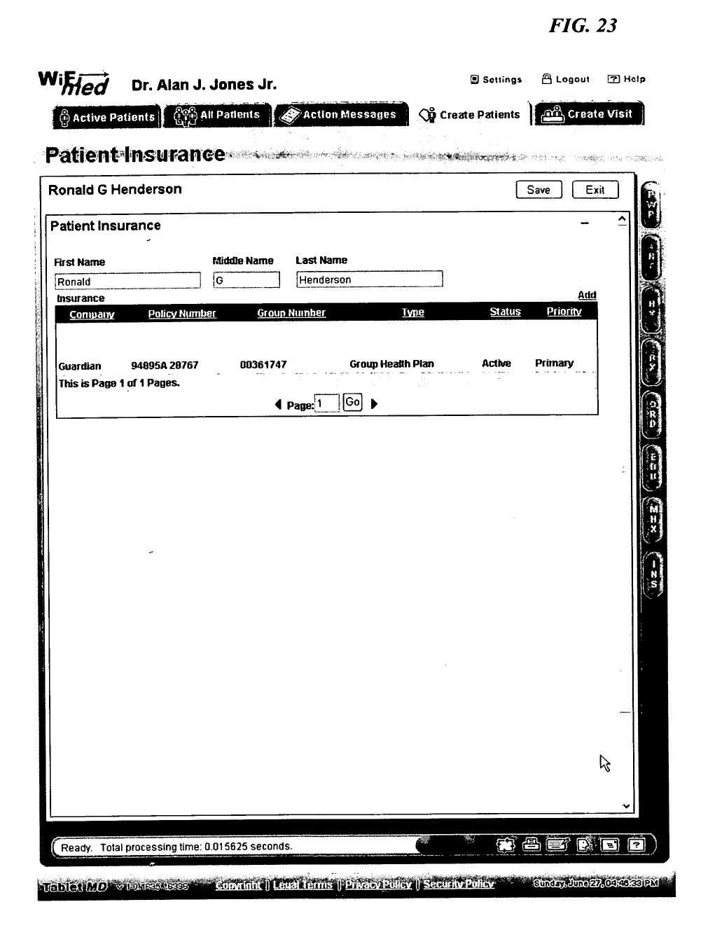

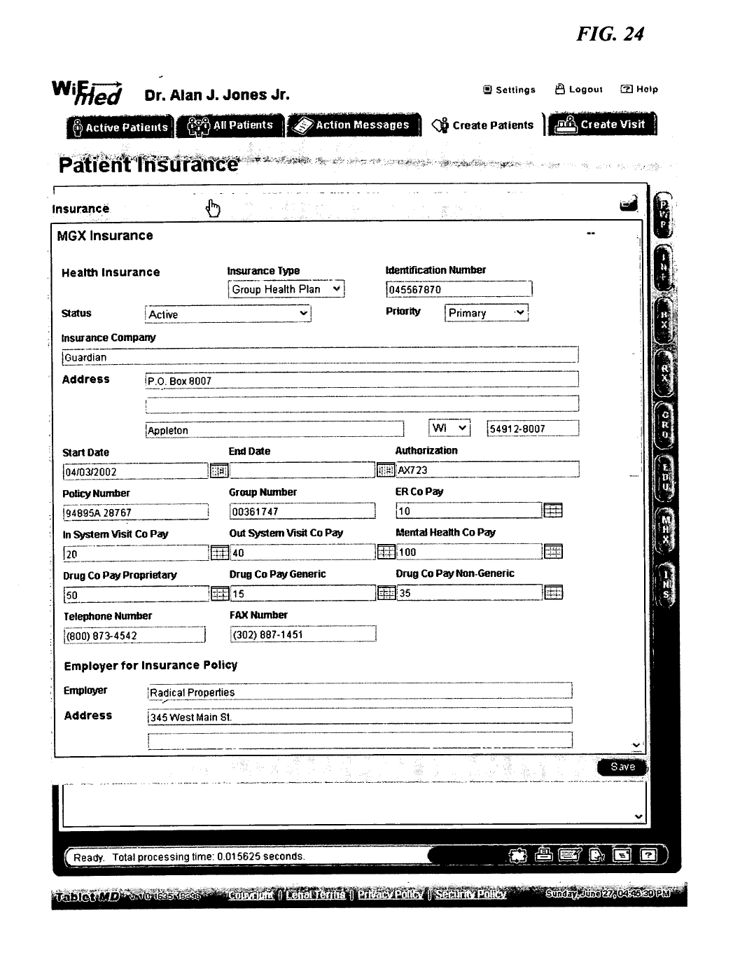

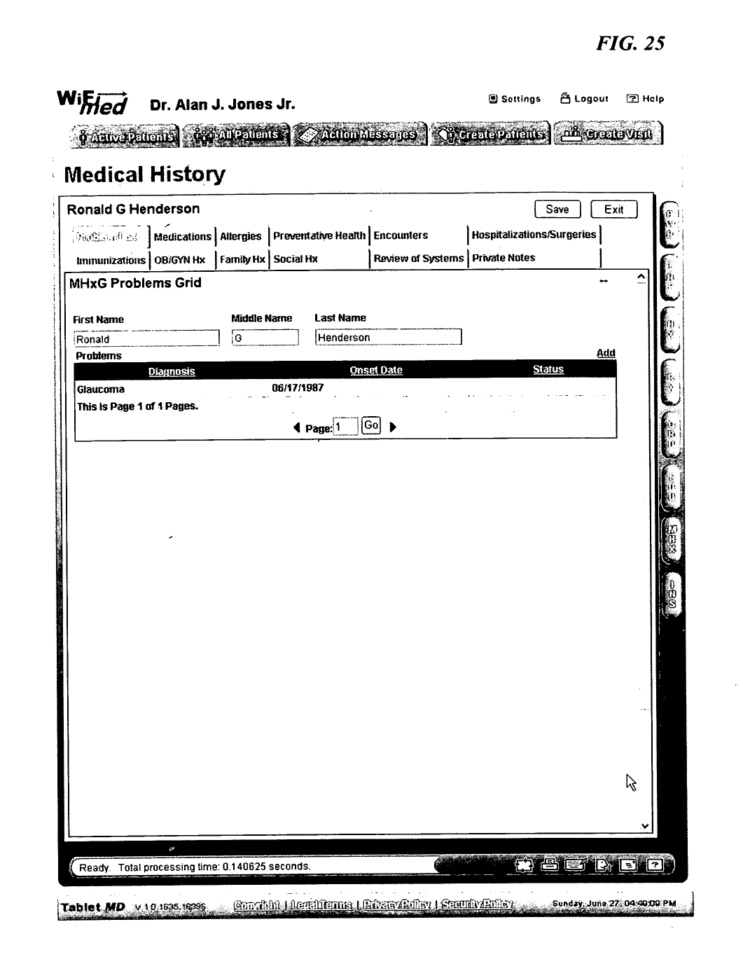

The user then selects the rule 1502 to be applied. Each rule 1502 has its own characteristics. Rules 1502 can be moved or deleted. The order in which the rules 1502 are executed is set by the user, but the system verifies upon saving the rule group if the user has logically implemented a business rules grouping 1503. The business rule engine is used for sub-systems such as medication selection, as seen in FIG. 14 and prescription writer to check for interaction conflicts.

The business rule engine is the basis for the messaging system which alerts the various healthcare professionals of actions to be taken or results to be reviewed or initiated. As with the other technologies employed within the inventive process, the business rule engine, although initially delivering a set of technology immediately useable by the practice, the practice can add, modify and delete rules to personalize and customize the practice environment.

6. Specialized Databases

The preferred embodiment of the present invention incorporates two essential databases. The Clinical Pharmacological Database contains all the drugs which a practice may use including generic names, manufacturers, interaction notations, allergic reactions, and general descriptions. The table is employed to input all medications used by the patient or to be used by the patient. The SnoMED Database, developed by the American College of Pathology, implements a cross reference of topic materials—body structure, conditions, medications, diseases—which the inventive process utilizes to aid a physician in the use of domain knowledge and to establish the various codes (i.e. ICD and E&M) that are required by Medicare and Insurance companies.

These databases are in a raw textual and proprietary format that requires the host server to convert them into useable formats, establish the cross reference information, and extract the information needed for coding and knowledge generation.

7. Cross Mapping Technology (CMT)

One of the major requirements of any new patient encounter environment is the ability to talk with other applications—Electronic Medical Record and Practice Management applications —and external environments—labs and hospitals—and testing equipment—EKG, EEG, X-ray. Implementing transfer of information can be expensive and time consuming. The mapping process is simplified through a graphical interface.

The types of transfer which can take place are Database to Database—Synchronization, HTML—Import Only, HTML—Export Only, XML—Import Only, XML—Export Only, HL7—Synchronization, 837—Export Only, ASCII—Export Only, ASCII—Import Only, and File to File—Synchronization. CMT moves beyond the standard import/export capabilities of competing systems and when possible establishes mappings which correlate to records both in the Tablet MD database and in the target system. When changes take place, the mapping is able to extract only the changes from the target application. This allows for greatly enhanced performance.

8. Segmented Workflow

The inventive patient workflow process ties together all the above elements and their functions into a virtually transparent approach which optimizes the process used by the healthcare professionals, and particularly a physician, for a patient visit and follow up. The preferred embodiment of the inventive process begins by scheduling a patient visit or encounter. The scheduling sub-system checks for conflicts, allows for the selection of the process to be performed, provides multiple schedule availabilities based on the procedure to be performed and its duration, aids in the selection of examining rooms, and schedules instrumentation which will be used during an encounter. The schedule handles practice visits, non-practice visits such as labs, and surgery schedules.

Once the schedule has been established, each time the physician, signs on Tablet MD, the preferred embodiment of the present invention displays the physician schedule. Once the schedule has been established, each time the physician, as example, signs on Tablet MD, displays the physician schedule. Once the face sheet is reviewed the user selects start and the application kicks off managing all the information and procedures needed for the particular ailment being reported by the patient. Every form is listed in the workflow under the categories established by the practice. Forms are displayed, again personalized to the user's specific requirements. Business rules check for consistencies throughout the process. There may be a need to add or delete forms from the process if the doctor notices any additional problems or the process being requested is not the one for the patient. By tapping on the ADD button in the PWP window, the doctor can select other processes or forms to be included.

The forms are grouped by the category assigned at form generation and the user can decide where in the PWP the added form should be placed. At the completion of a patient encounter, the physician can choose to have an encounter report automatically generated to be used for submission to the health insurance company, given to the patient, or sent to a referring physician.

9. Security

The Tablet MD application takes into account all the requirements of HIPAA compliancy to protect patient records and their unauthorized use. Information transferred between the Tablet PC and Server is encrypted and compressed. The same is true of information moving from the practice server to the host corporate server. Tablet MD maintains forms required for the patient to execute to establish HIPAA, practice, and surgical compliance. The inventive process checks for appropriate access to Tablet MD. The practice is able to establish a threshold limit on how many times a user can sign on the Tablet MD system and not gain access and the application immediately erases all information on the hard drive pertaining to patient records.

The use of the inventive patient workflow process approach differentiates Tablet MD product from other encounter/clinical record systems for the following reasons. The technology is a totally integrated system and not fragmented. The patient workflow process is designed for the wireless environment. The inventive patient workflow process uses the capabilities of the Tablet PC plus voice recognition. The process is configured to the way each individual wants to use the application and desires to work their encounter requirements. All information is verified against output requirements associated with insurance payers and laboratory orders for completeness. All output meets external requirements in terms of look and interface translating from the doctor input format. Client systems may be disconnected from main servers to travel with the doctor when outside the practice.

1. A method of optimizing the patient workflow process, the method dependent upon the delineation and demarcation of steps taken during the healthcare professional-patient encounter, said method comprising:
interfacing with electronic medical record applications to display patient information and initiate the encounter;
gathering additional patient information;
entering the information into an electronic system which may be customized to a particular physician's preferences;
generating a patient workflow derived from the information entered;
modifying the workflow during assessment;
conducting the patient examination according to the generated patient workflow;
capturing dictated information into an audio file;
converting the audio file into a voice profile for a particular physician;
submitting the voice profile for transcription; and
compiling diagnostic and prescriptive information for payor authorization and processing

2. The method of claim 1, wherein gathering patient information includes synchronization of data between internal and external databases.

3. The method of claim 1, wherein the patient workflow modification comprises tailoring a generalized workflow to the specialized needs of the patient examined.

4. A system for optimizing the patient workflow process, the system comprising:
a wireless output device for displaying health-related information, including diagnostic and plan care information;
a wireless input device for entering diagnostic and plan care information;
a memory for storing a computer program;
a microphone for dictating descriptive data and other patient-related information, and
a processor for executing the computer program.

5. The system of claim 4 in which the computer program optimizes the patient workflow process by accepting from the health professional a diagnosis entered through the wireless input device, automatically displaying component elements pre-selected by the healthcare professional, the component elements being arranged in forms created by the healthcare professional, and initiating or modifying an assessment after review and acceptance by the health professional.

6. The system of claim 4, wherein the wireless input device is a keyboard used to enter data and patient information, the data and patient information being transmitted over a wireless communications link to a computer network for transcription or storage.

7. The system of claim 4, wherein the computer program communicates with databases accessible trough a computer network, thereby permitting the program to recall information from the databases and display the information on the wireless output device.

8. The system of claim 4, wherein the computer program communicates with a medical records database, a payor insurance or authorization database, and other medical and patient information databases.

9. A system for compiling, sychronizing, and communicating health-related information, the system linking the health professional to medical records, payor insurance or authorization guidelines, reference information, and service providers, comprising:
a computer in data communications with one or more internal and external computer databases or networks;
a wireless portable computing device including an input device and a display device for use during the patient workflow process, the wireless portable computing device in data communication with the computer network; and
a memory storing a computer program that prescribes a suggested workflow for the healthcare professional-patient encounter.
